(19) United States
(12) Patent Application Publication
(10) Pub. No.: US 2024/0310993 A1
(43) Pub. Date: Sep. 19, 2024

(54) NON-TRANSITORY COMPUTER READABLE MEDIUM, INFORMATION DISPLAY SYSTEM, AND INFORMATION PROCESSING METHOD

(71) Applicant: FUJIFILM BUSINESS INNOVATION CORP., Tokyo (JP)

(72) Inventor: Takao MAEKAWA, Kanagawa (JP)

(73) Assignee: FUJIFILM BUSINESS INNOVATION CORP., Tokyo (JP)

(21) Appl. No.: 18/363,463

(22) Filed: Aug. 1, 2023

(30) Foreign Application Priority Data
Mar. 15, 2023 (JP) 2023-040485

(51) Int. Cl. G06F 3/0485; G06F 3/0482; G06F 3/04845; G06F 3/0488

(52) U.S. Cl. CPC G06F 3/0485; G06F 3/0482; G06F 3/04845; G06F 3/0488

(57) ABSTRACT

A non-transitory computer readable medium stores a program causing a computer to execute a process for information processing. The process includes changing display positions of plural items in accordance with a direction of a scroll operation on a screen, and stopping the scroll operation when a specific item among the plural items has been moved outside a display range in response to the scroll operation or displaying the specific item on part of the screen when an input is provided to a predetermined region on the screen.

### CROSS-REFERENCE TO RELATED APPLICATIONS

This application is based on and claims priority under 35 USC 119 from Japanese Patent Application No. 2023-040485 filed Mar. 15, 2023.

### BACKGROUND

### (i) Technical Field

The present disclosure relates to a non-transitory computer readable medium, an information display system, and an information processing method.

### (ii) Related Art

In Japanese Unexamined Patent Application Publication No. 2021-189987, an information processing apparatus that includes a memory and a processor configured to display a first image that is able to be selected, display a second image so as to be superimposed in a region including a region in which the first image is displayed in such a manner that at least part of the first image is invisible, and in a case where the second image is displayed so as to be superimposed in such a manner that at least part of the first image is invisible, perform control so as to receive an operation for making the first image visible and able to be selected, while continuing to display the second image in the region including the region in which the first image is displayed, is disclosed.

### SUMMARY

Aspects of non-limiting embodiments of the present disclosure relate to, in a configuration for changing display positions of a plurality of objects by performing a scroll operation on a screen, re-displaying a specific item that has been moved outside a display range, without requiring scrolling back in order to re-display the specific item that has been moved outside the display range.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a non-transitory computer readable medium storing a program causing a computer to execute a process for information processing, the process including changing display positions of a plurality of items in accordance with a direction of a scroll operation on a screen, and stopping the scroll operation when a specific item among the plurality of items has been moved outside a display range in response to the scroll operation or displaying the specific item on part of the screen when an input is provided to a predetermined region on the screen.

### BRIEF DESCRIPTION OF THE DRAWINGS

Exemplary embodiments of the present disclosure will be described in detail based on the following figures, wherein:

FIG. 1 is a diagram for explaining a configuration of an image forming apparatus according to a first exemplary embodiment;

FIG. 2 is a diagram for explaining a display range of a screen in the first exemplary embodiment and illustrating a state in which e-mail addresses, which are specific items, are displayed;

FIG. 3 is a diagram, which is continued from FIG. 2, for explaining the display range of the screen in the first exemplary embodiment and illustrating a state in which the display range of the screen is scrolled;

FIG. 4 is a diagram, which is continued from FIG. 3, for explaining the display range of the screen in the first exemplary embodiment and illustrating a state in which the e-mail addresses have been scrolled out from the display range;

FIG. 5 is a diagram, which is continued from FIG. 4, for explaining the display range of the screen in the first exemplary embodiment and illustrating a state in which e-mail addresses are displayed as a simplified banner;

FIG. 6 is a diagram, which is continued from FIG. 5, for explaining the display range of the screen in the first exemplary embodiment and illustrating a state in which the simplified banner is selected and detailed banners are displayed;

FIG. 7 is a diagram, which is continued from FIG. 6, for explaining the display range of the screen in the first exemplary embodiment and illustrating a state in which one of the detailed banners is selected and an e-mail address input item is displayed;

FIG. 8 is a flowchart in which a processing procedure in the first exemplary embodiment is set;

FIG. 9 is a diagram for explaining a display range of a screen in a first modification of the first exemplary embodiment and illustrating a state in which e-mail addresses have been scrolled out from the display range;

FIG. 10 is a diagram, which is continued from FIG. 9, for explaining the display range of the screen in the first modification of the first exemplary embodiment and illustrating a state in which e-mail addresses are displayed aligned with second items;

FIG. 11 is a flowchart in which a processing procedure in the first modification of the first exemplary embodiment is set;

FIG. 12 is a diagram for explaining a display range of a screen in a second modification of the first exemplary embodiment and illustrating a state in which a number-of-copies item, which is a specific item, is displayed;

FIG. 13 is a diagram, which is continued from FIG. 12, for explaining the display range of the screen in the second modification of the first exemplary embodiment and illustrating a state in which the display range of the screen is scrolled;

FIG. 14 is a diagram, which is continued from FIG. 13, for explaining the display range of the screen in the second modification of the first exemplary embodiment and illustrating a state in which the number-of-copies item has been scrolled out from the display range;

FIG. 15 is a diagram, which is continued from FIG. 14, for explaining the display range of the screen in the second modification of the first exemplary embodiment and illustrating a state in which the number-of-copies item is displayed as a simplified banner;

FIG. 16 is a diagram, which is continued from FIG. 15, for explaining the display range of the screen in the second modification of the first exemplary embodiment and illustrating a state in which the simplified banner is selected and a number-of-copies input item is displayed;

FIG. 17 is a diagram for explaining a display range of a screen in a second exemplary embodiment and illustrating a state in which a banner handle for an e-mail address is displayed;

FIG. 18 is a diagram, which is continued from FIG. 17, for explaining the display range of the screen in the second exemplary embodiment and illustrating a state in which an input is provided to the banner handle;

FIG. 19 is a flowchart in which a processing procedure in the second exemplary embodiment is set;

FIG. 20 is a flowchart in which a processing procedure in a modification of the second exemplary embodiment is set;

FIG. 21 is a diagram for explaining a display range of a screen in a third exemplary embodiment and illustrating a state in which a plurality of items for which settings have been changed are displayed;

FIG. 22 is a diagram, which is continued from FIG. 21, for explaining the display range of the screen in the third exemplary embodiment and illustrating a state in which the display range of the screen is scrolled;

FIG. 23 is a diagram, which is continued from FIG. 22, for explaining the display range of the screen in the third exemplary embodiment and illustrating a state in which the plurality of items for which settings have been changed have been scrolled out from the display range;

FIG. 24 is a diagram, which is continued from FIG. 23, for explaining the display range of the screen in the third exemplary embodiment and illustrating a state in which the plurality of items for which settings have been changed are displayed as simplified banners; and

FIG. 25 is a flowchart in which a processing procedure in the third exemplary embodiment is set.

### DETAILED DESCRIPTION

Examples of exemplary embodiments of the present disclosure will be described below with reference to drawings. In the drawings, the same or equivalent component elements and parts are assigned the same reference signs. Furthermore, dimensional ratios in the drawings are exaggerated for the convenience of explanation and may differ from actual ratios.

### First Exemplary Embodiment

### (Hardware Configuration)

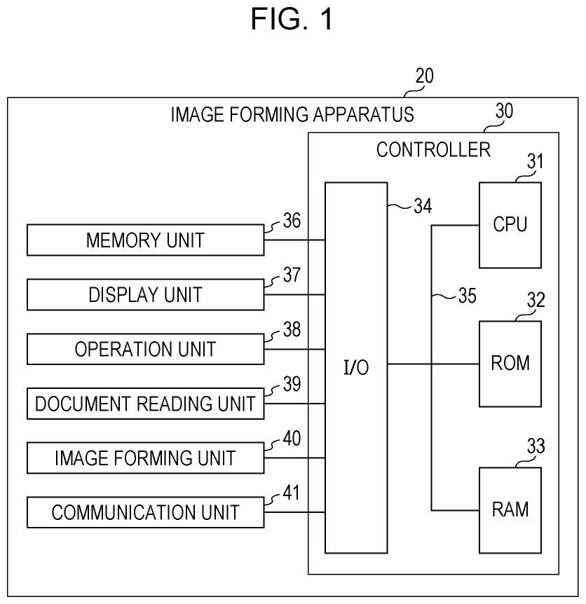

FIG. 1 is a block diagram illustrating a hardware configuration of an image forming apparatus 20 according to a first exemplary embodiment of the present disclosure. The image forming apparatus 20 is an example of an information display system according to an exemplary embodiment of the present disclosure and includes, as described later, a display unit 37 including a screen on which various types of information are displayed.

As illustrated in FIG. 1, the image forming apparatus 20 includes a controller 30 that controls operation of the image forming apparatus 20. In the controller 30, a central processing unit (CPU) 31, a read only memory (ROM) 32, a random access memory (RAM) 33, and an input/output unit (I/O) 34 are connected via a bus 35 in such a manner that they are able to communicate with one another.

The CPU 31 is a central arithmetic processing unit. The CPU 31 executes various programs and controls various units. That is, the CPU 31 reads a program from the ROM 32 or a memory unit 36, which will be described later, and executes the program by using the RAM 33 as a work area. The CPU 31 performs control of the components described above and various arithmetic processes in accordance with a program recorded in the ROM 32 or the memory unit 36. The CPU 31 is an example of a “processor”.

Various programs and various data are stored in the ROM 32. The RAM 33 serves as a work area and temporarily stores a program or data.

The memory unit 36, the display unit 37, an operation unit 38, a document reading unit 39, an image forming unit 40, and a communication unit 41 are connected to the I/O 34. The memory unit 36, the display unit 37, the operation unit 38, the document reading unit 39, the image forming unit 40, and the communication unit 41 are able to communicate with the CPU 31 via the I/O 34.

The memory unit 36 is a memory device such as a hard disk drive (HDD), a solid state drive (SSD), or a flash memory and stores various programs and various data. In the first exemplary embodiment, an information processing program for performing at least a determination process, which will be described later, is stored in the memory unit 36. The information processing program may be installed in advance in the image forming apparatus 20. Alternatively, the information processing program may be stored in a nonvolatile storage medium or distributed through a network and installed into the image forming apparatus 20 in an appropriate manner. The nonvolatile storage medium may be, for example, a compact disc-read only memory (CD-ROM), a magneto-optical disk, an HDD, a digital versatile disc-read only memory (DVD-ROM), a flash memory, or a memory card.

As the display unit 37, for example, a liquid crystal display or an organic electroluminescence (EL) display is used. The display unit 37 in this exemplary embodiment is an example of a “screen”.

In this exemplary embodiment, the display unit 37 and the operation unit 38 are integrated together as a touch panel. The operation unit 38 receives various instructions from a user of the image forming apparatus 20 including, for example, an instruction for starting to print a document and an instruction for starting to copy a document. Furthermore, the display unit 37 displays various types of information including a result of processing performed in response to an instruction received from the user, a notification regarding the processing, and the like.

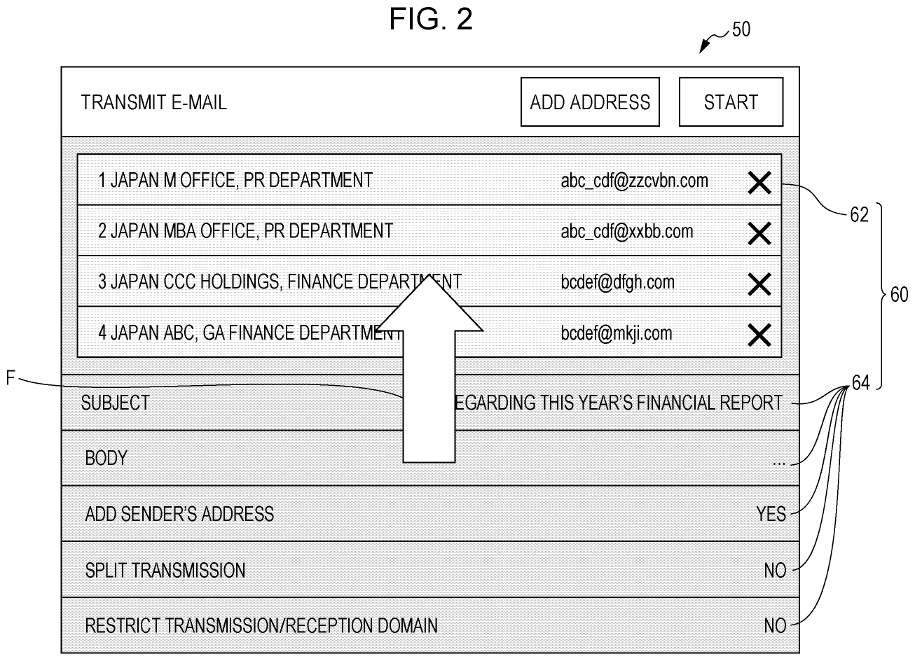

As described later, a plurality of objects 60 are displayed on the screen of the touch panel (see FIG. 2 and other figures), and display positions of the plurality of objects 60 are changed by a scroll operation by a user. In this exemplary embodiment, a scroll operation includes flicking on the screen, swiping on the screen, and the like by a user.

Furthermore, the operation unit 38 may further include various operation keys such as cursor keys, numeric kays, and a start key as well as the touch panel mentioned above. A scroll operation on the touch panel may be performed using various operation keys.

The document reading unit 39 captures, sheet by sheet, a document placed on a paper feed table of an automatic document feeder, which is not illustrated in FIG. 1, provided in an upper part of the image forming apparatus 20 and optically reads the captured document to obtain image information. The document reading unit 39 also optically reads a document placed on a document table such as a platen glass to obtain image information.

The image forming unit 40 forms images and the like on a recording medium such as paper, the images being based on image information read by the document reading unit 39, image information obtained from an external computer or the like connected via the network, or the like.

The communication unit 41 is an interface for communicating with other apparatuses. For such communications, for example, wired communication standards such as Ethernet® or fiber distributed data interface (FDDI) or wireless communication standards such as 4G, 5G, or Wi-Fi® are used.

For execution of the information processing program mentioned above, the image forming apparatus 20 uses the hardware resources mentioned above to perform a process based on the information processing program.

### (Screen Display Items)

FIG. 2 illustrates an example of a display range 50 displayed on the screen of the image forming apparatus 20 according to this exemplary embodiment. In the display range 50 illustrated in FIG. 2, a screen is displayed on which a user performs setting for transmission of document data read by the document reading unit 39 of the image forming apparatus to an address by an e-mail. As illustrated in FIG. 2, on the screen in this exemplary embodiment, the objects 60, which are horizontally long, are displayed, arranged in a vertical direction, and setting information on each of the objects 60 is able to be edited by an input operation by the user (more specifically, a touch on a region in which the object 60 is displayed). Hereinafter, the state illustrated in FIG. 2 will be referred to as an e-mail transmission screen.

In this exemplary embodiment, as illustrated in FIG. 2, the objects 60 indicating items such as an e-mail address, a subject, and a body are displayed in the display range 50 of the screen. Among the plurality of items, an e-mail address is an item to be displayed at the top among the objects 60 displayed on the e-mail transmission screen and is an item that is likely to be recognized as being important to the user compared to second items 64 for transmission of document data by e-mail. In this exemplary embodiment, an e-mail address is referred to as a first item 62. The first item 62 is an example of a specific item. Herein, as illustrated in FIG. 2, a plurality of sending addresses are set as e-mail addresses.

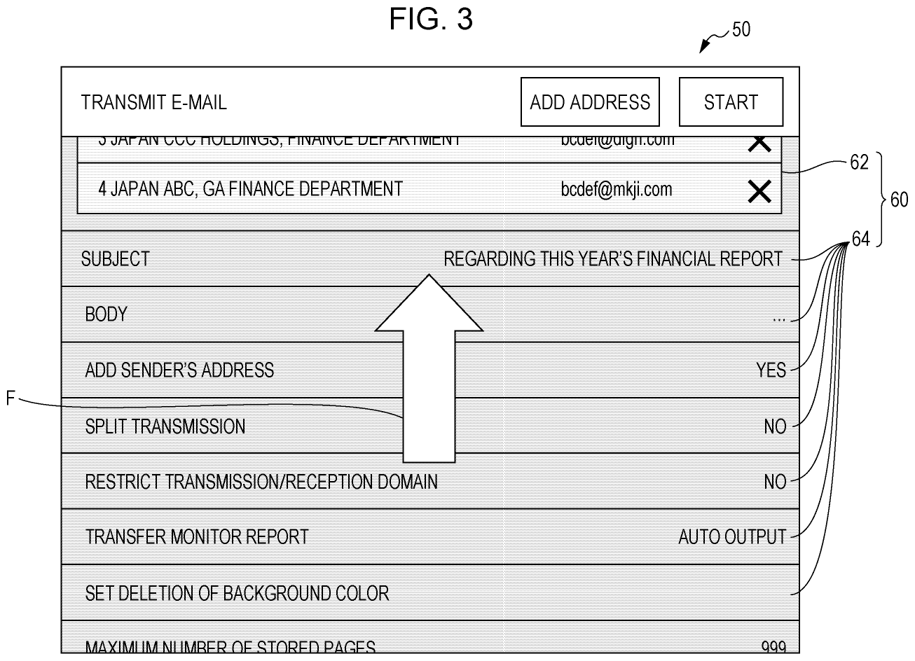

Furthermore, the objects 60 in this exemplary embodiment are moved in the same direction by a scroll operation by the user. For example, as illustrated in FIG. 2, in the case where the plurality of objects 60 including e-mail addresses are displayed, when a scroll operation in a direction of arrow F is performed, the individual objects 60 are moved toward the direction of the scroll operation, as illustrated in FIG. 3.

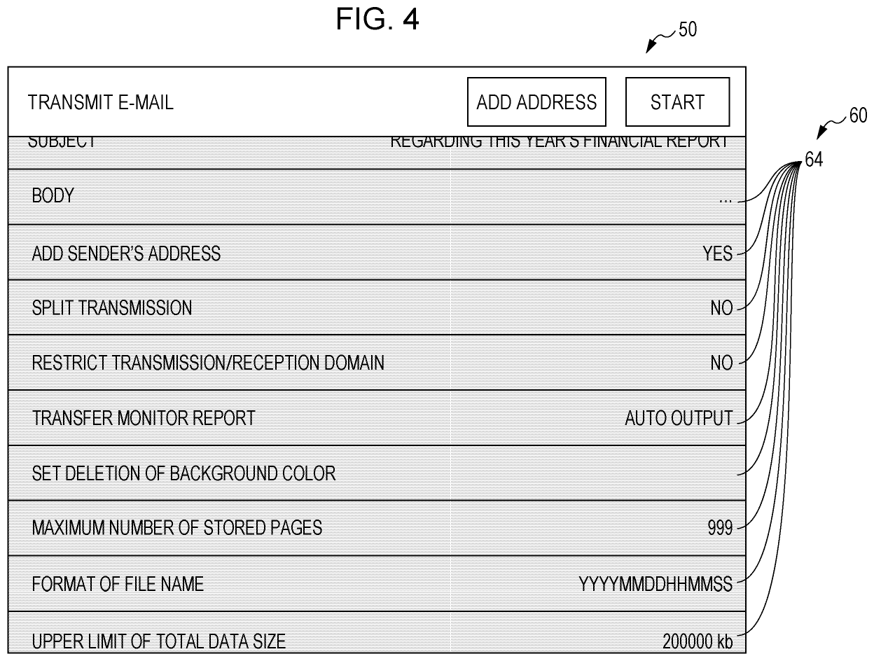

When the scroll operation continues to be performed, some objects 60 are moved outside the display range 50 of the screen and are thus not displayed on the screen. For example, FIG. 4 illustrates a state in which the first item 62 in the state illustrated in FIG. 3 has been moved outside the display range 50. Hereinafter, a state in which an object 60 has been moved outside the display range 50 will be referred to as a state in which the object is scrolled out. That is, in FIG. 4, the state in which the first item 62 is scrolled out is illustrated.

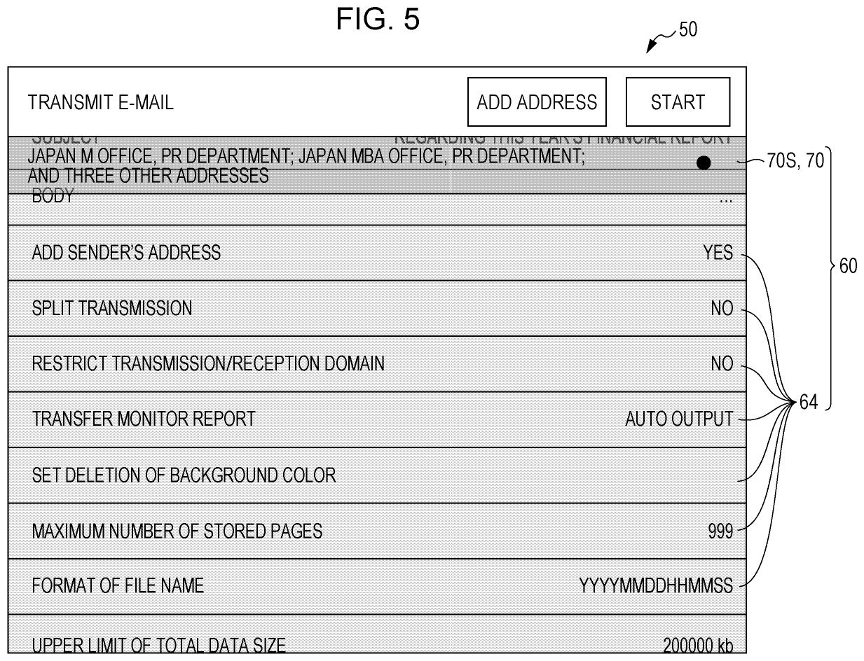

In this exemplary embodiment, in the case where a non-operation time, which is a predetermined time since the stop of a user operation in the state in which the first item 62 is scrolled out from the display range 50 of the screen, has passed, a simplified banner 70S is displayed, as illustrated in FIG. 5. In this exemplary embodiment, the non-operation time is, for example, three seconds.

The simplified banner 70S is an object 60 that is displayed so as to be superimposed on the second items 64, as illustrated in FIG. 5, and is displayed in such a manner that setting contents of the e-mail addresses as the first item 62 described above are abbreviated. The user is able to perform an input operation on the simplified banner 70S. Furthermore, as illustrated in FIG. 5, transparency processing for allowing the user to be able to recognize the second items 64 on which the simplified banner 70S is superimposed is performed on the simplified banner 70S.

Furthermore, as illustrated in FIG. 5, the simplified banner 70S and the second items 64 are displayed in different manners. More specifically, in this exemplary embodiment, the background color of the simplified banner 70S is different from the background color of the second items 64.

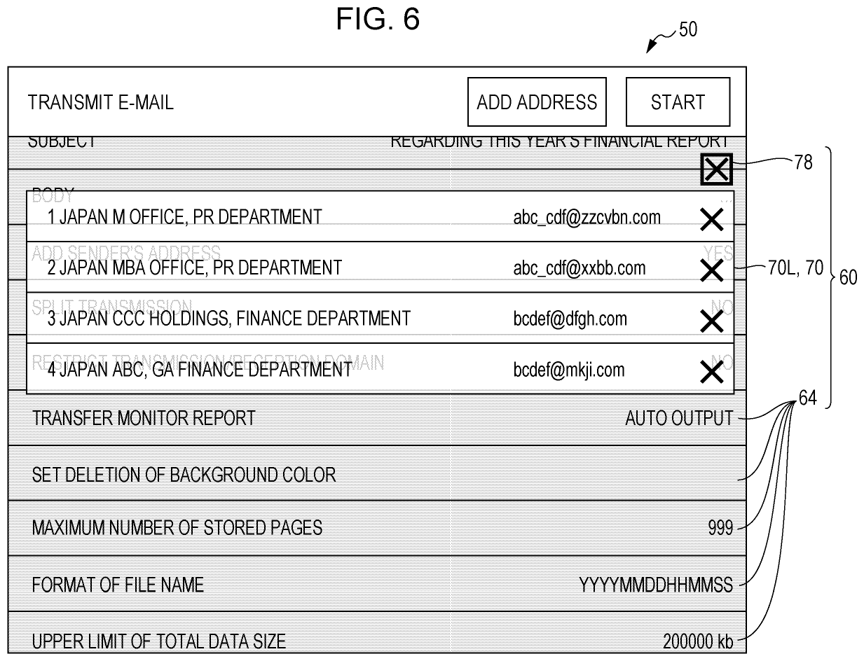

When the user performs an input operation (specifically, a touching operation on the screen) on the simplified banner 70S in the state illustrated in FIG. 5, details of the first item 62 are displayed as a detailed banner 70L, as illustrated in FIG. 6. More specifically, in the state illustrated in FIG. 6, a plurality of sending addresses set as e-mail addresses are displayed. When the user touches the screen, the items of the plurality of sending addresses are able to be edited by the user. Hereinafter, in the case where the simplified banner 70S and the detailed banner 70L are not particularly distinguished from each other, the simplified banner 70S and the detailed banner 70L will be simply referred to as banners 70.

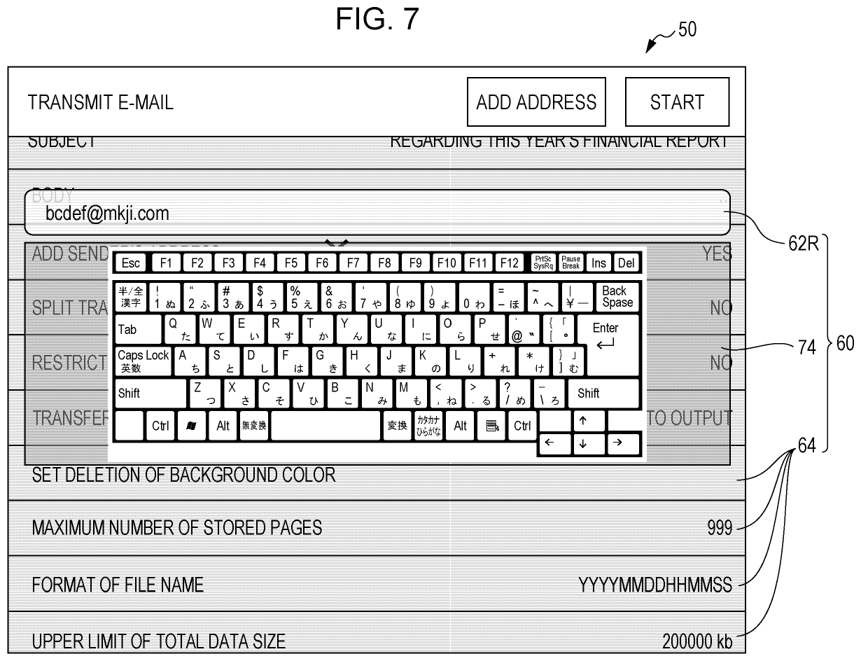

When an input operation is performed on one of a plurality of detailed banners 70L indicating a plurality of sending addresses in the state illustrated in FIG. 6, a screen keyboard 74 and an e-mail address input item 62R for editing a sending address are displayed, as illustrated in FIG. 7. That is, the screen enters a state in which the user is able to edit a sending address for an e-mail.

A deletion input part 78 for deleting the detailed display is added to the detailed banners 70L indicating the details, as illustrated in FIG. 6. When the user performs an input operation on the deletion input part 78, display of the screen turns into the state illustrated in FIG. 5.

In this exemplary embodiment, as illustrated in FIG. 5, in the state in which the simplified banner 70S is displayed, when the user performs an operation on a display region other than the displayed simplified banner 70S, the simplified banner 70S is deleted from display on the screen. For example, in the state illustrated in FIG. 5, when the user performs an input operation on a second item 64, the simplified banner 70S is deleted, and the state illustrated in FIG. 4 is entered. Also in the states illustrated in FIGS. 6 and 7, when the user performs an input operation on a second item 64, the state illustrated in FIG. 4 is entered.

Furthermore, in this exemplary embodiment, as illustrated in FIG. 5, in the state in which the simplified banner 70S is displayed, when the user performs a scroll operation, the simplified banner 70S is deleted from the screen.

In this exemplary embodiment, the CPU 31 has a non-operation timer function for counting the time elapsed since the last operation by the user. The non-operation timer is reset every time that a user operation is received. A specific time when the non-operation timer is reset will be described later.

Furthermore, a scroll operation by the user is not particularly limited. In this exemplary embodiment, however, when the user swipes the screen, which is a touch panel, the individual objects 60 are moved toward the direction of the swipe.

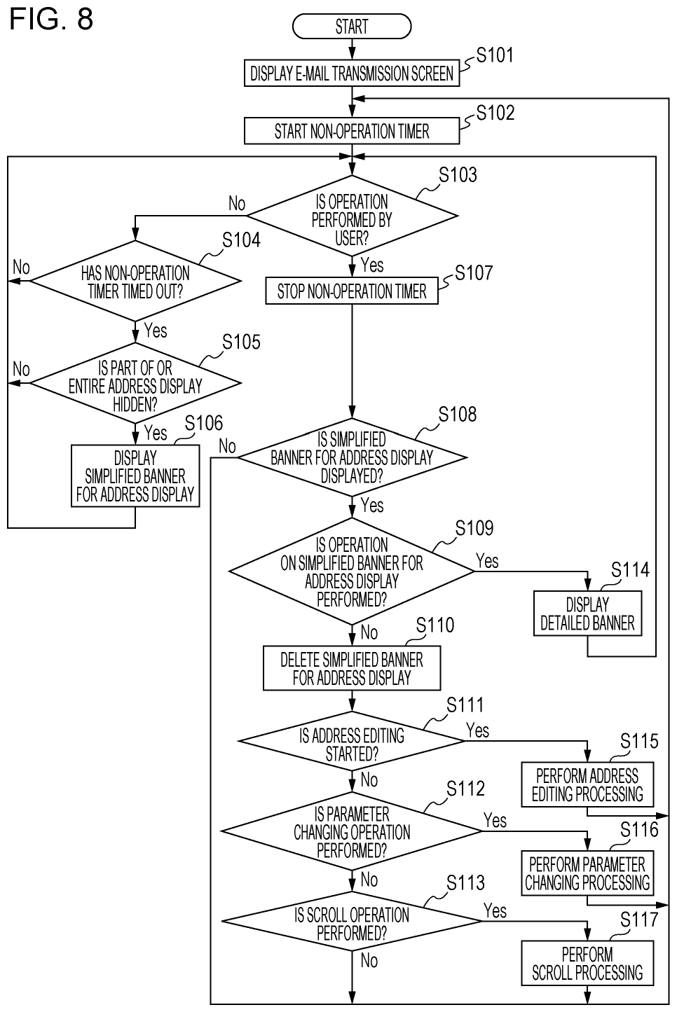

Next, a processing procedure for the CPU 31 to execute the information processing program and display the objects 60 in the display range 50 of the screen in this exemplary embodiment will be described with reference to FIG. 8. In this exemplary embodiment, in the case where the e-mail transmission screen is displayed before the processing procedure starts, an e-mail address, which is the first item 62, is displayed in the display range 50.

As illustrated in FIG. 8, the CPU 31 displays the e-mail transmission screen in step S101, and then proceeds to step S102. In step S102, the CPU 31 resets and then starts the non-operation timer to count the time during which the user does not perform any operation. Then, the CPU 31 proceeds to step S103.

In step S103, the CPU 31 determines whether or not an operation is performed by the user. In the case where the result of the determination in step S103 is affirmative, the CPU 31 proceeds to step S107. In the case where the result of the determination in step S103 is negative, the CPU 31 proceeds to step S104.

In step S104. The CPU 31 determines whether or not the counter value of the non-operation timer is longer than the non-operation time. In the case where the result of the determination in step S104 is affirmative, the CPU 31 proceeds to step S105. In the case where the result of the determination in step S104 is negative, the CPU 31 proceeds to step S103.

In step S105, the CPU 31 determines whether or not part of or all the e-mail addresses are scrolled out from the display range 50 of the screen. In the case where the result of the determination in step S105 is affirmative, the CPU 31 proceeds to step S106. In the case where the result of the determination in step S105 is negative, the CPU 31 proceeds to step S103.

In step S106, the CPU 31 displays the e-mail addresses as the simplified banner 70S, as illustrated in FIG. 5. Then, in the case where it is determined that the e-mail addresses are displayed as the simplified banner 70S, the CPU 31 proceeds to step S103.

Then, when the result of the determination in step S103 is affirmative and the CPU 31 proceeds to step S107, the CPU 31 stops the non-operation timer. Then, the CPU 31 proceeds to step S108.

In step S108, the CPU 31 determines whether or not the simplified banner 70S for address display is displayed in the display range 50. In the case where the result of the determination in step S108 is affirmative, the CPU 31 proceeds to step S109. In the case where the result of the determination in step S108 is negative, the CPU 31 proceeds to step S102.

In step S109, the CPU 31 determines whether or not an input operation on the simplified banner 70S is performed by the user. In the case where it is determined that a scroll operation or an input operation on a second item 64 is performed by the user, the CPU 31 obtains a negative determination result in step S109. In the case where the result of the determination in step S109 is affirmative, the CPU 31 proceeds to step S114. In the case where the result of the determination in step S109 is negative, the CPU 31 proceeds to step S110.

In step S114, the CPU 31 displays the detailed banner 70L, as illustrated in FIG. 6. Then, in the case where it is determined that the detailed banner 70L is displayed, the CPU 31 proceeds to step S103.

In step S110, the CPU 31 deletes the simplified banner 70S displayed on the screen. Then, the CPU 31 proceeds to step S111.

In step S111, the CPU 31 determines whether or not an input operation on the detailed banner 70L (e-mail address) is performed by the user. In the case where the result of the determination in step S111 is affirmative, the CPU 31 proceeds to step S115. In the case where the result of the determination in step S111 is negative, the CPU 31 proceeds to step S112.

In step S115, the CPU 31 receives an input operation on the detailed banner 70L by the user. In step S115, in the case where editing of the detailed banner 70L is performed by the user, as illustrated in FIG. 7, the CPU 31 performs processing for changing an e-mail address. In the case where it is determined that the processing for editing the e-mail address is completed, the CPU 31 deletes the detailed banner 70L and then displays the simplified banner 70S. Then, the CPU 31 proceeds to step S102.

In step S112, the CPU 31 determines whether or not an operation for changing a parameter for a second item 64 is performed by the user. In the case where the result of the determination in step S112 is affirmative, the CPU 31 proceeds to step S116. In the case where the result of the determination in step S112 is negative, the CPU 31 proceeds to step S113.

In step S116, the CPU 31 receives the operation for changing the parameter for the second item 64 by the user. In the case where it is determined that the processing for changing the parameter for the second item 64 is completed, the CPU 31 proceeds to step S102.

In step S113, the CPU 31 determines whether or not a scroll operation is performed by the user. In the case where the result of the determination in step S113 is affirmative, the CPU 31 proceeds to step S117. In the case where the result of the determination in step S113 is negative, the CPU 31 proceeds to step S102.

In the case where an input operation on the deletion input part 78 is performed by the user and the result in the determination in step S113 is negative, the CPU 31 deletes the detailed banner 70L and then displays the simplified banner 70S. Then, the CPU 31 proceeds to step S102.

In step S117, the CPU 31 changes display of the display range 50 of the screen in response to the scroll operation by the user. Then, in the case where it is determined that the change of display of the display range 50 of the screen is completed, the CPU 31 proceeds to step S102.

The CPU 31 displays the objects 60 in the display range 50 of the screen in accordance with the procedure described above. Next, operation and effects in the processing procedure of the information processing program according to this exemplary embodiment will be described.

### Operation and Effects

In the processing procedure of the information processing program according to this exemplary embodiment, with the configuration for changing display positions of the plurality of objects 60 by performing a scroll operation on the screen, when the non-operation time has passed, the first item 62 that has been moved outside the display range 50 is displayed again as the simplified banner 70S. Thus, when the user wants to check the scrolled out first item 62, that is, an e-mail address, the user is able to check the first item 62 without performing a scroll operation for displaying the first item 62.

Thus, with the information processing program according to this exemplary embodiment, the first item 62 that has been moved outside the display range 50 is able to be displayed again without scrolling back being required in order to re-display the first item 62 that has been moved outside the display range 50.

Furthermore, in the processing procedure of the information processing program according to this exemplary embodiment, when a deletion operation on the screen by the user is received in the state in which a banner 70 is displayed on part of the screen, display of the banner 70 is deleted. When the user deletes display of the banner 70, only the second items 64 are displayed on the screen.

Thus, with the information processing program according to this exemplary embodiment, compared to the case where display of the banner 70 is stopped when a predetermined time has passed, the display range 50 of the screen is able to be secured.

Furthermore, with the information processing program according to this exemplary embodiment, when an input operation, as a deletion operation, is performed on the deletion input part 78 added to the banner 70, the banner 70 is deleted from the screen.

Thus, with the information processing program according to this exemplary embodiment, compared to the case where display of the banner 70 is deleted by selection of a second item 64 other than the banner 70, a situation in which display of the banner 70 is unintentionally deleted is prevented.

With the information processing program according to this exemplary embodiment, when selection of a second item 64 other than the banner 70 is performed as a deletion operation by the user, the banner 70 is deleted from the screen.

Thus, with the information processing program according to this exemplary embodiment, compared to the case where display of the banner 70 is deleted by input on the deletion input part 78, the number of operations to be performed by the user is reduced.

Furthermore, when a scroll operation on the screen is performed as a deletion operation by the user, the banner 70 is deleted from the screen.

Thus, with the information processing program according to this exemplary embodiment, compared to the case where display of the banner 70 is deleted by input on the deletion input part 78, the number of operations to be performed by the user is reduced.

Furthermore, in the processing procedure of the information processing program according to this exemplary embodiment, the banner 70 is displayed so as to be superimposed on the display position of a second item 64 other than the banner 70.

Thus, with the information processing program according to this exemplary embodiment, compared to the case where the banner 70 is displayed aligned with the second items 64, a change of the display manner of items other than the banner 70 is reduced.

Furthermore, in the processing procedure of the information processing program according to this exemplary embodiment, transparency processing for making the banner 70 transparent so that the user is able to recognize the second items 64 on which the banner 70 is superimposed is performed on the banner 70.

Thus, with the information processing program according to this exemplary embodiment, compared to the case where the banner 70 is not transparent, the user is able to easily recognize the second items 64 that are hidden by display of the banner 70.

Furthermore, in the processing procedure of the information processing program according to this exemplary embodiment, the banner 70 and the second items 64 other than the banner 70 are displayed in different manners.

Thus, with the information processing program according to this exemplary embodiment, compared to the case where the banner 70 and the second items 64 are displayed in the same manner, the user is able to easily recognize display of the banner 70.

Furthermore, in the processing procedure of the information processing program according to this exemplary embodiment, the banner 70 and the second items 64 are displayed in different colors, as display manners.

Thus, with the information processing program according to this exemplary embodiment, compared to the case where the banner 70 and the second items 64 are displayed in different fonts, the user is able to easily recognize display of the banner 70.

Furthermore, in the processing procedure of the information processing program according to this exemplary embodiment, when an input operation on the detailed banner 70L is performed in the state in which the detailed banner 70L is displayed, the detailed banner 70L is enabled to be edited.

Thus, with the information processing program according to this exemplary embodiment, set contents are able to be edited by an input operation on the banner 70.

Furthermore, in the image forming apparatus 20 according to this exemplary embodiment, the controller 30 re-displays the first item 62 that has been moved outside the display range 50 of the screen as the banner 70.

Thus, with the image forming apparatus 20 according to this exemplary embodiment, the first item 62 that has been moved outside the display range 50 is able to be displayed again without scrolling back being required in order to re-display the first item 62 that has been moved outside the display range 50.

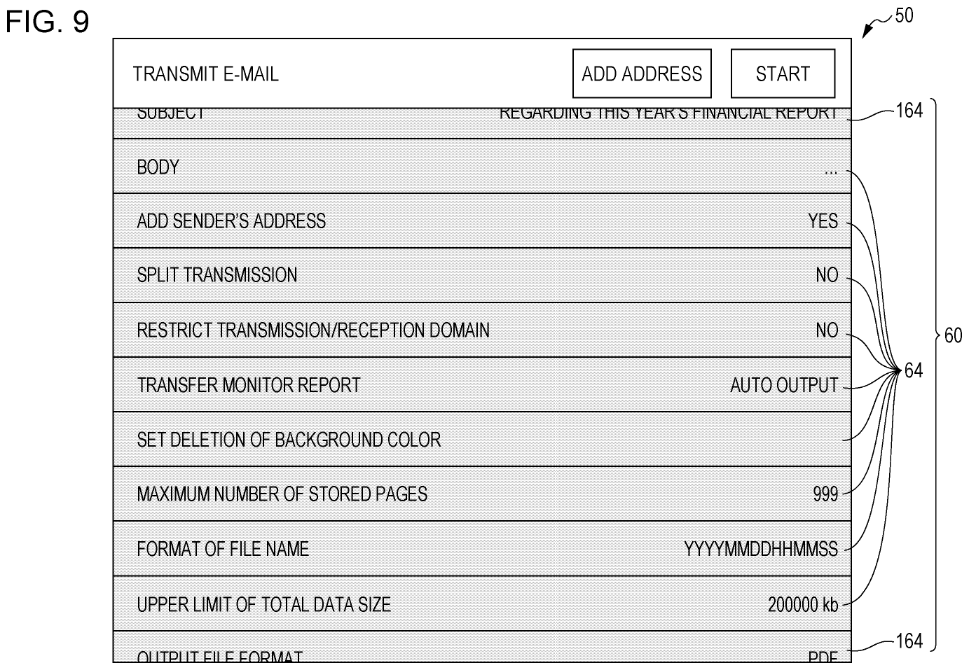

Next, a first modification of this exemplary embodiment will be described with reference to FIGS. 9 to 11.

### First Modification

### (Screen Display Items)

FIG. 9 is a diagram illustrating an e-mail transmission screen in the first modification of this exemplary embodiment. In this modification, the first item 62 is an e-mail address, as in the first exemplary embodiment.

As illustrated in FIG. 9, due to a scroll operation by the user, part of an item may be scrolled out. For example, in FIG. 9, partially displayed items 164, part of which are scrolled out, are present in an upper part and a lower part of the display range 50 of the screen.

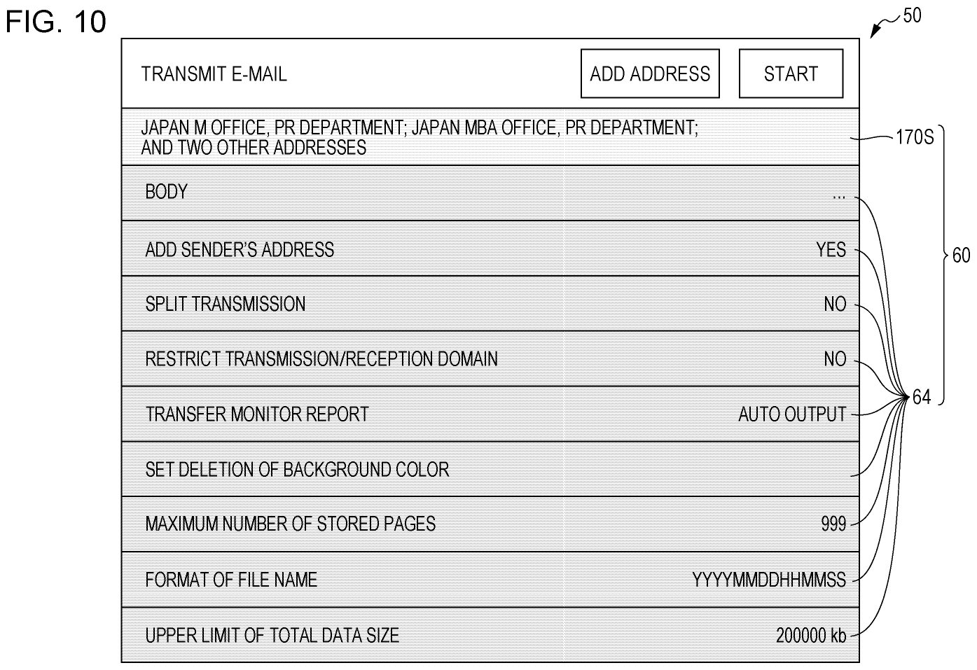

In this modification, as illustrated in FIG. 10, the partially displayed items 164 are deleted, and a simplified banner 170S indicating the first item 62 is displayed aligned with the second items 64. More specifically, in this modification, the simplified banner 170S is displayed as an object 60 with the same size as each of the second items 64 in such a manner that the simplified banner 170S is inserted among the second items 64 arranged in the display range 50 of the screen.

Furthermore, in this modification, as illustrated in FIG. 10, the simplified banner 170S is displayed in such a manner that the upper edge of the object 60 and the upper edge of the display range 50 of the screen overlap. Furthermore, the second items 64 are moved downward not by the length in the vertical direction of the partially displayed item 164 displayed in the upper part of the display range 50 of the screen but by the length in the vertical direction of the simplified banner 170S in the state illustrated in FIG. 9 and displayed.

Furthermore, an item the whole of which is displayed in the display range 50 of the screen in the state illustrated in FIG. 9 is also displayed in the display range 50 of the screen in FIG. 10. That is, in this modification, the simplified banner 170S is displayed while display of a second item 64 the whole of which has been displayed in the display range 50 being maintained.

In this modification, as illustrated in FIG. 10, the color of the simplified banner 170S is different from the color of the other objects 60.

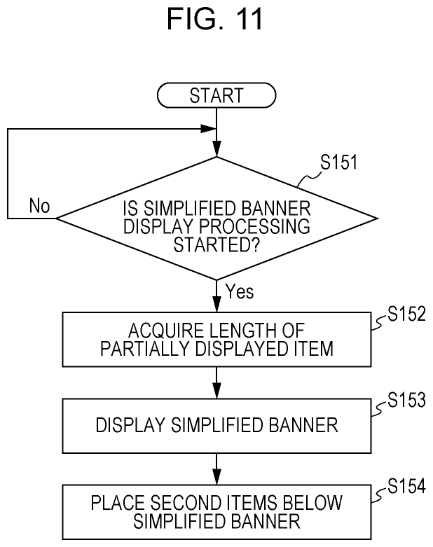

Next, a processing procedure for the CPU 31 to execute the information processing program and display the objects 60 in the display range 50 of the screen in this modification will be described with reference to FIG. 11. In this modification, an operation (step S106 in FIG. 8) corresponding to a processing operation for displaying the simplified banner 170S will be described, and the other operations are similar to those in the first exemplary embodiment.

As illustrated in FIG. 11, in step S151, the CPU 31 determines whether or not processing for displaying a simplified banner is started. In the case where the result of the determination in step S151 is affirmative, the CPU 31 proceeds to step S152. In the case where the result of the determination in step S151 is negative, the CPU 31 repeats the processing of step S151.

In step S152, the CPU 31 acquires the length of a part of a partially displayed item 164 that is partially displayed in the display range 50 of the screen, the part of the partially displayed item 164 being displayed in the display range 50 of the screen. In the case where the result of the determination in step S152 is positive, the CPU 31 proceeds to step S153.

In step S153, the CPU 31 displays the simplified banner 170S at the top of the display range 50 of the screen. Then, the CPU 31 proceeds to step S154.

In step S154, the CPU 31 displays the second items 64 that were displayed in the display range 50 of the screen at the time when the processing of step S151 was performed below the simplified banner 170S. More specifically, the CPU 31 moves the second items 64 that have been displayed in the display range 50 of the screen downward by the value acquired in step S152.

The CPU 31 displays the objects 60 in the display range 50 of the screen in accordance with the procedure described above. Next, operation and effects in this modification will be described.

### Operation and Effects

In the processing procedure of the information processing program according to this modification, a specific item is displayed while display of an item the whole of which has been displayed in the display range 50 being maintained. Thus, when the user wants to check the scrolled out first item 62, the user is able to check the first item 62 without performing a scroll operation for displaying the first item 62.

Thus, with the information processing program according to this modification, compared to the case where the first item 62 is displayed so as to be superimposed on a second item 64, a situation in which the user is not able to recognize the second item 64 that is hidden by the first item 62 is prevented.

Other operation and effects are similar to those in the first exemplary embodiment.

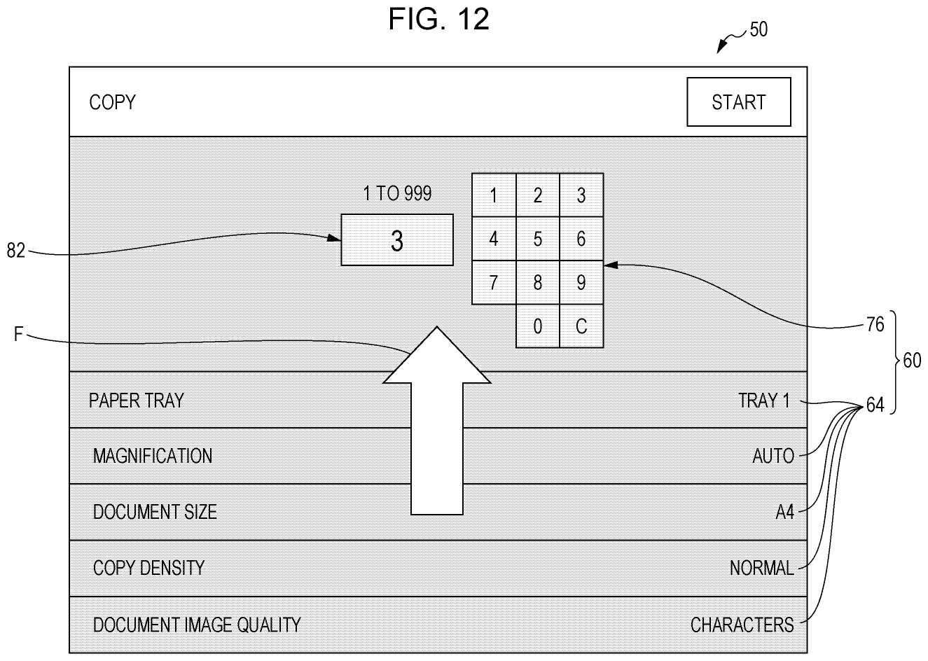

Next, a second modification of this exemplary embodiment will be described with reference to FIGS. 12 to 16.

### Second Modification

### (Screen Display Items)

FIG. 12 is a diagram illustrating the second modification of this exemplary embodiment. In this modification, a screen on which the user performs setting for copying and printing document data read by the document reading unit 39 of the image forming apparatus 20 is displayed in the display range 50 of the screen. In this modification, the state illustrated in FIG. 12 will be referred to as a copy setting screen.

In this modification, as illustrated in FIG. 12, a plurality of items including a number-of-copies item 82, a screen numeric keypad 76, a paper tray, magnification, and document size are displayed in the display range 50 of the screen. Among the plurality of items, the number-of-copies item 82 is an example of a specific item in this modification and is an item that is likely to be recognized as being important to the user compared to the second items 64.

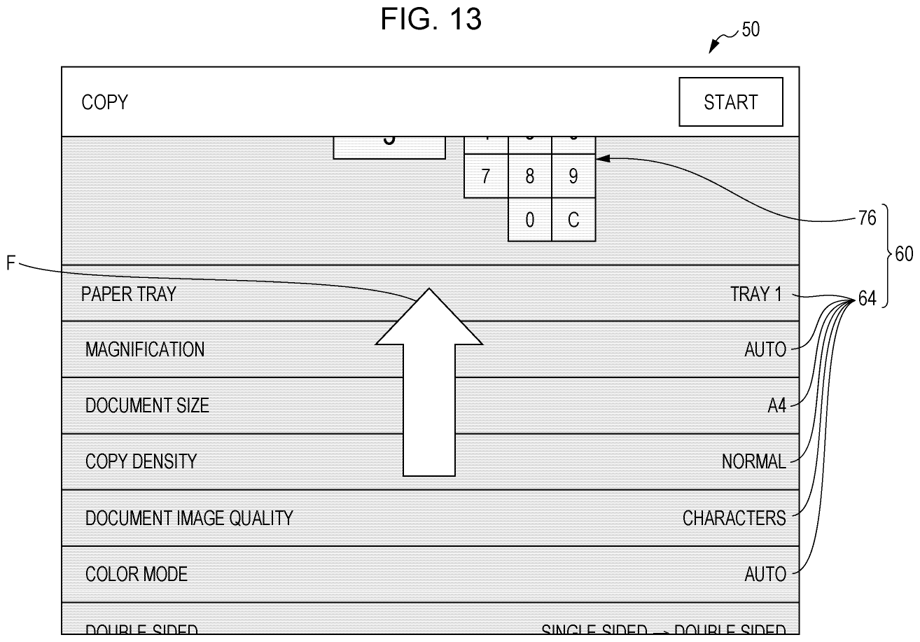

Furthermore, also in this modification, the objects 60 are moved in the same direction by a scroll operation by the user. For example, as illustrated in FIG. 12, in the case where the plurality of objects 60 including the number-of-copies item 82 are displayed, when a scroll operation in the direction of the arrow F is performed, the individual items are moved toward the direction of the scroll operation, as illustrated in FIG. 13.

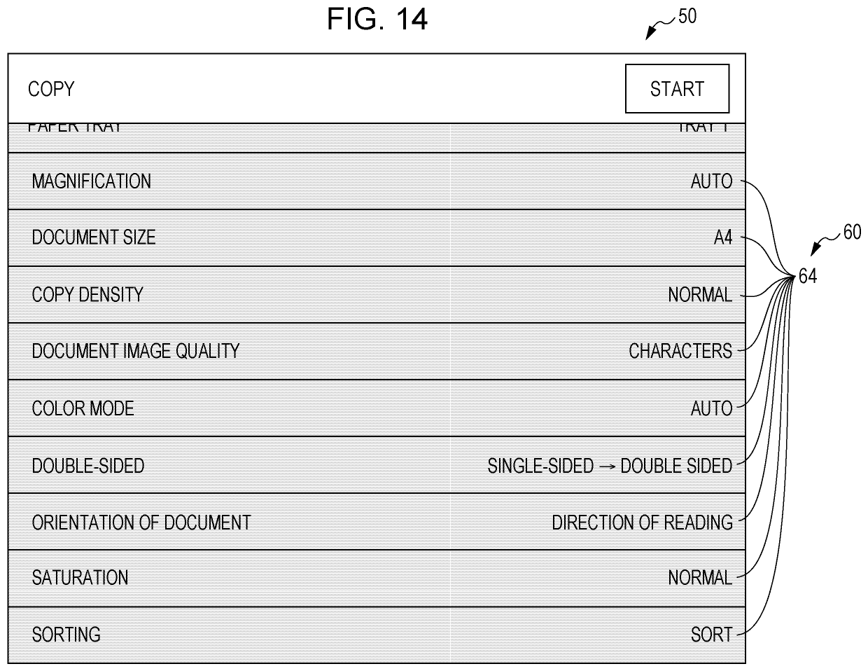

Then, when the scroll operation continues to be performed, the individual objects 60 are moved outside the display range 50 of the screen, as illustrated in FIG. 14.

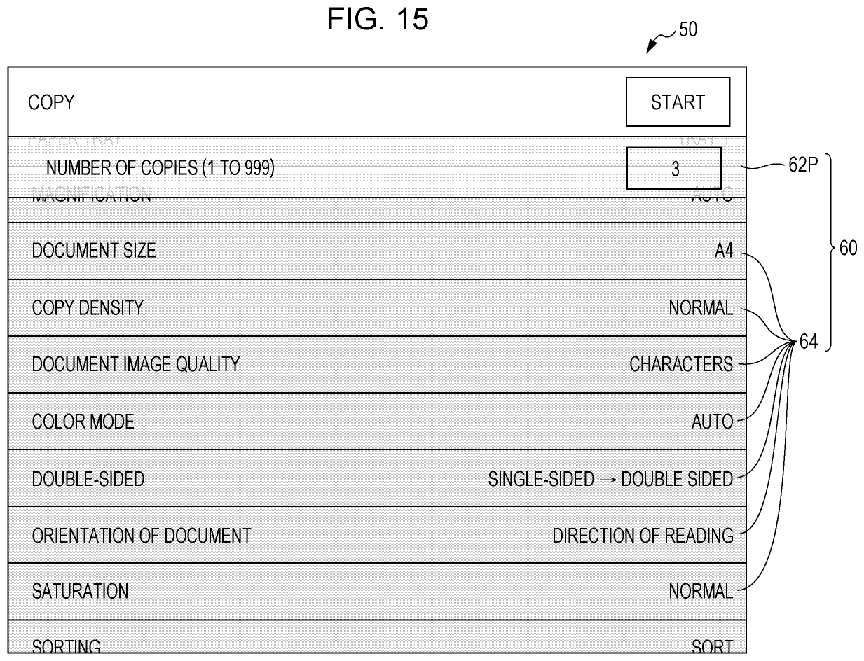

In this modification, when the non-operation time has passed since the user stops an operation in the state in which the number-of-copies item 82 is scrolled out from the display range 50 of the screen, the number-of-copies item 82 is displayed as the simplified banner 70S, as illustrated in FIG. 15.

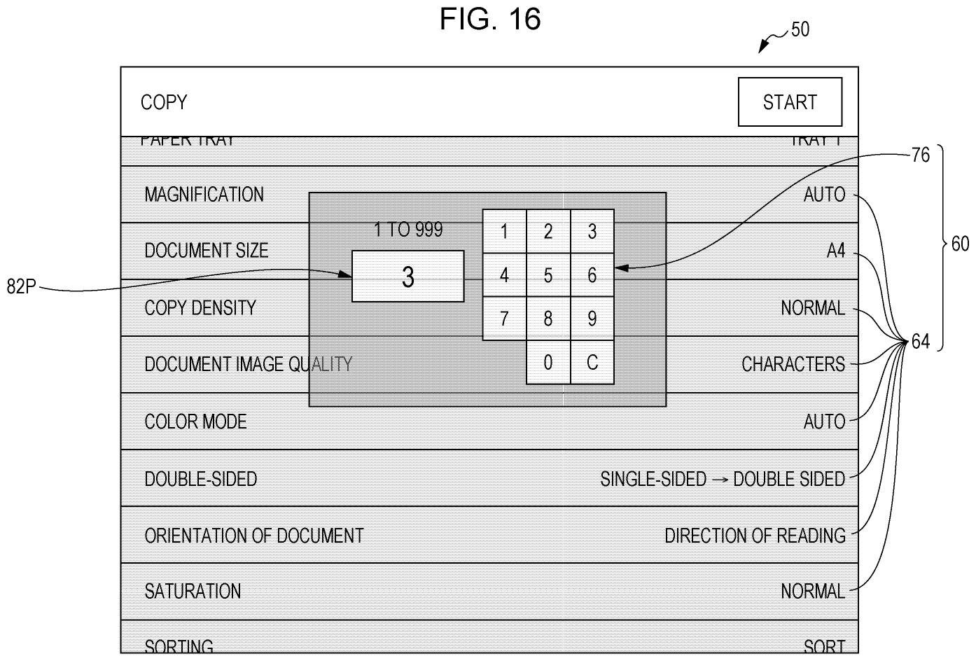

Then, when the user performs an input operation on the simplified banner 70S in the state illustrated in FIG. 15, the details of the number-of-copies item 82 are displayed as the detailed banner 70L, as illustrated in FIG. 16. More specifically, in FIG. 16, a number-of-copies input item 82P and the screen numeric keypad 76 are displayed.

Other configurations and operations are similar to those in the first exemplary embodiment. That is, the specific item is not limited to an e-mail address on the e-mail transmission screen as long as the item is important to the user, and the specific item may be the number-of-copies item 82 on the copy setting screen.

### Operation and Effects

Operation sand effects similar to those in the first exemplary embodiment are achieved also in this modification. Furthermore, the CPU 31 may perform both the processing operations of the program according to this modification and the processing operations of the program according to the first modification.

### Other Modifications

Regarding display and deletion of the banner 70 in this exemplary embodiment, the CPU 31 may gradually change the display range 50 of the screen over a predetermined time. In this case, compared to a case where a specific item is displayed instantaneously, the user is able to easily recognize display of the specific item. Furthermore, compared to the case where the specific item is displayed instantaneously, an erroneous operation by the user is reduced.

Furthermore, in this exemplary embodiment, in response to display or deletion of the banner 70, the CPU 31 may implement notification means for notifying the user of display or deletion of a specific item. The notification means is, for example, visually or aurally notifying the user of occurrence of a change, such as flashing the display screen or beeping. Also in this case, compared to the case where the CPU 31 does not provide the user with a notification in response to display or deletion of a specific item, the user is able to easily recognize display of the specific item. Furthermore, compared to the case where no notification is provided to the user in response to display or deletion of a specific item, an erroneous operation by the user is reduced.

Furthermore, in this exemplary embodiment, the color of the background of the simplified banner 70S is different from the color of the background of the second items 64. However, the color of characters in the simplified banner 70S may be different from the color of characters in the second items 64. Furthermore, both the color of the background and the color of characters of the simplified banner 70S may be different from the color of the background and the color of characters of the second items 64. Furthermore, characters of the simplified banner 70S may be displayed in a font different from the font of characters of the second items 64. That is, making the color of the background, the color of characters, and the font of characters of the banner 70 different from the color of the background, the color of characters, and the font of characters of the second items 64 is an example of displaying the banner 70 and the second items 64 in different display manners.

Furthermore, in this exemplary embodiment, as illustrated in FIG. 5, the shape of the simplified banner 70S is equivalent to the shapes of the second items 64. However, the shape of the simplified banner 70S may be different from the shapes of the second items 64. For example, the length in the vertical direction of the simplified banner 70S may be longer than the length in the vertical direction of each of the second items 64. That is, making the shape of the banner 70 different from the shapes of the second items 64 is an example of displaying the banner 70 and the second items 64 in different display manners.

Furthermore, as a processing procedure in this exemplary embodiment, the simplified banner 70S may be displayed when the user swipes from the edge of the display range 50 of the screen. That is, a user's operation for swiping from the edge of the display range 50 of the screen is an example of an input to a predetermined region on the screen in this exemplary embodiment.

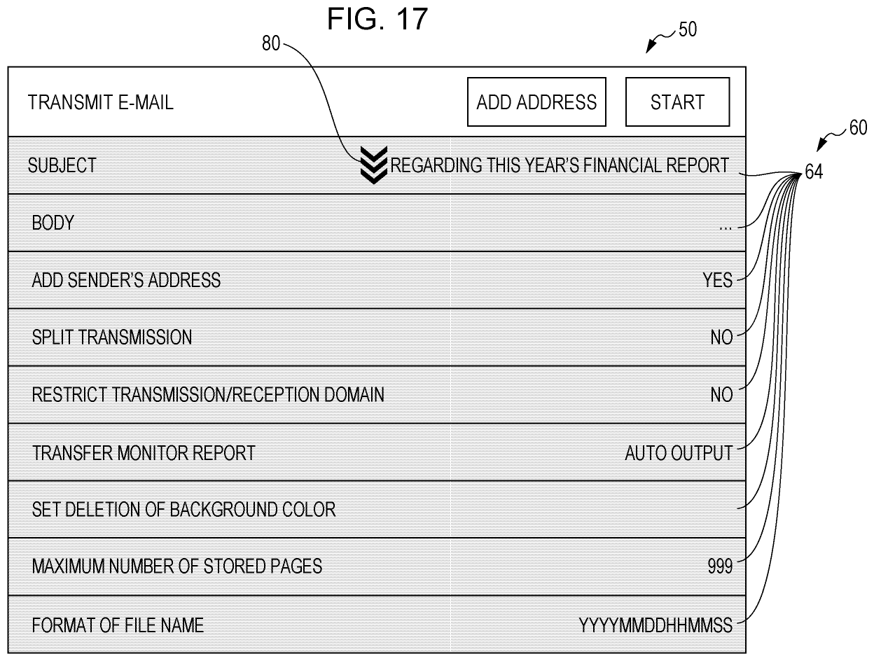

Next, a second exemplary embodiment of the present disclosure will be described with reference to FIGS. 17 to 19. In this exemplary embodiment, components similar to those in the first exemplary embodiment will be denoted by signs similar to those in the first exemplary embodiment and the modifications thereof, and detailed description of those components will be omitted.

### Second Exemplary Embodiment

### (Screen Display Items)

FIG. 17 is a diagram illustrating the second exemplary embodiment of the present disclosure. In this exemplary embodiment, a banner handle 80, which is an example of a display mark, is displayed when the first item 62 is scrolled out on the e-mail transmission screen, as illustrated in FIG. 17.

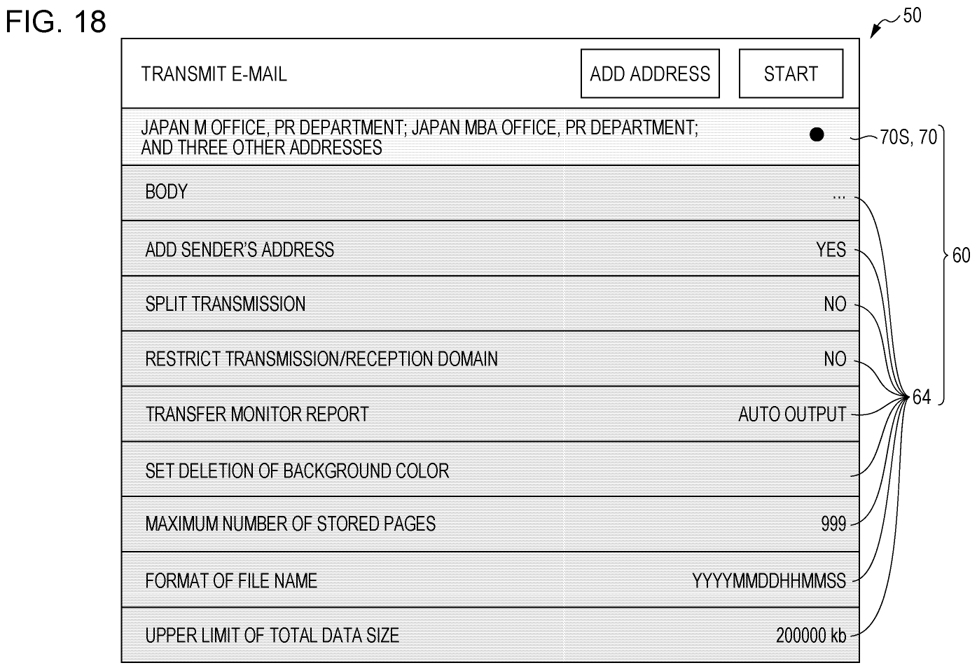

When the user performs an input operation on the banner handle 80 in the state illustrated in FIG. 17, the simplified banner 70S is displayed, as illustrated in FIG. 18. In the state illustrated in FIG. 18, operations in the case where the user has operated the simplified banner 70S are similar to those in the first exemplary embodiment.

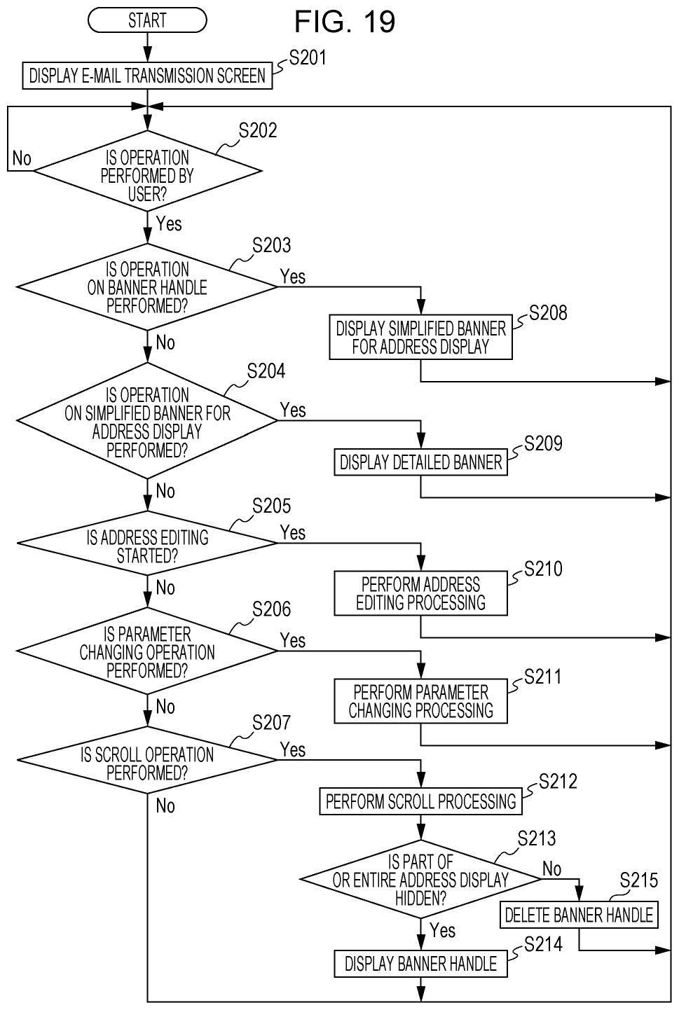

Next, a processing procedure for the CPU 31 to execute the information processing program and display the objects 60 in the display range 50 of the screen in this exemplary embodiment will be described with reference to FIG. 19.

As illustrated in FIG. 19, the CPU 31 displays the e-mail transmission screen in step S201, and then proceeds to step S202.

In step S202, the CPU 31 determines whether or not an operation is performed by the user. In the case where the result of the determination in step S202 is affirmative, the CPU 31 proceeds to step S203. In the case where the result of the determination in step S202 is negative, the CPU 31 repeats the processing of step S202.

In step S203, the CPU 31 determines whether or not an input operation on the banner handle 80 is performed by the user. In the case where the banner handle 80 is not displayed (for example, in the case where the CPU 31 proceeds to step S203 before the banner handle 80 is displayed), the CPU 31 obtains a negative determination result. In the case where the result of the determination in step S203 is affirmative, the CPU 31 proceeds to step S208. In the case where the result of the determination in step S203 is negative, the CPU 31 proceeds to step S204.

In step S204, the CPU 31 determines whether or not an input operation on the simplified banner 70S is performed by the user. In the case where the simplified banner 70S is not displayed (for example, in the case where the CPU 31 proceeds to step S204 before the simplified banner 70S is displayed), the CPU 31 obtains a negative determination result. In the case where it is determined that a scroll operation or an input operation on a second item 64 is performed by the user, the CPU 31 obtains a negative determination result in step S204. In the case where the result of the determination in step S204 is affirmative, the CPU 31 proceeds to step S209. In the case where the result of the determination in step S204 is negative, the CPU 31 proceeds to step S205.

In step S205, the CPU 31 determines whether or not an input operation on the detailed banner 70L is performed by the user. In the case where the result of the determination in step S205 is affirmative, the CPU 31 proceeds to step S210. In the case where the result of the determination in step S205 is negative, the CPU 31 proceeds to step S206.

In step S206, the CPU 31 determines whether or not an operation for changing a parameter for a second item 64 is performed by the user. In the case where the result of the determination in step S206 is affirmative, the CPU 31 proceeds to step S211. In the case where the result of the determination in step S206 is negative, the CPU 31 proceeds to step S207.

In step S207, the CPU 31 determines whether or not a scroll operation is performed by the user. In the case where the result of the determination in step S207 is affirmative, the CPU 31 proceeds to step S212. In the case where the result of the determination in step S207 is negative, the CPU 31 proceeds to step S202.

In step S212, the CPU 31 changes display of the display range 50 of the screen in response to the scroll operation by the user. Then, in the case where it is determined that scroll processing is completed, the CPU 31 proceeds to step S213.

In step S213, the CPU 31 determines whether or not part of or the entire first item 62 is scrolled out from the display range 50 of the screen. In the case where the result of the determination in step S213 is affirmative, the CPU 31 proceeds to step S214. In the case where the result of the determination in step S213 is negative, the CPU 31 proceeds to step S215.

In step S214, the CPU 31 displays the banner handle 80 in the display range 50 of the screen. Then, the CPU 31 proceeds to step S202.

In step S215, the CPU 31 deletes the banner handle 80 from the display range 50 of the screen. Then, the CPU 31 proceeds to step S202.

In step S208, the CPU 31 displays e-mail addresses as the simplified banner 70S, as illustrated in FIG. 18. Then, in the case where it is determined that e-mail addresses are displayed as the simplified banner 70S, the CPU 31 proceeds to step S202.

In step S209, the CPU 31 displays the detailed banner 70L (see FIG. 6). In the case where it is determined that the detailed banner 70L is displayed, the CPU 31 proceeds to step S202.

In step S210, the CPU 31 receives the input operation on the detailed banner 70L by the user. When editing on the detailed banner 70L is performed by the user in step S209, the CPU 31 performs processing for changing the first item 62, as illustrated in FIG. 7. In the case where it is determined that the processing for editing an e-mail address is completed, the CPU 31 deletes the detailed banner 70L and then displays the simplified banner 70S. Then, the CPU 31 proceeds to step S202.

In step S211, the CPU 31 receives the operation for changing the parameter for the second item 64 by the user. In the case where it is determined that the processing for changing the parameter for the second item 64 is completed, the CPU 31 proceeds to step S202.

The CPU 31 displays the objects 60 in the display range 50 of the screen in accordance with the procedure described above. Next, operation and effects in this exemplary embodiment will be described.

### Operation and Effects

In the processing procedure of the information processing program according to this exemplary embodiment, with the configuration for changing the display positions of the plurality of objects 60 by performing a scroll operation on the screen, when the user performs an input operation on the banner handle 80, the first item 62 that has been moved outside the display range 50 is displayed again as the simplified banner 70S. Thus, when the user wants to check the scrolled out first item 62, the user is able to check the first item 62 without performing a scroll operation for displaying the first item 62.

Thus, with the information processing program according to this exemplary embodiment, the first item 62 that has been moved outside the display range 50 is able to be displayed again without scrolling back being required in order to re-display the first item 62 that has been moved outside the display range 50.

Other operation and effects are similar to those in the first exemplary embodiment. Furthermore, the CPU 31 may perform both the processing operations of the program according to this exemplary embodiment and the processing operations of the program according to the first exemplary embodiment.

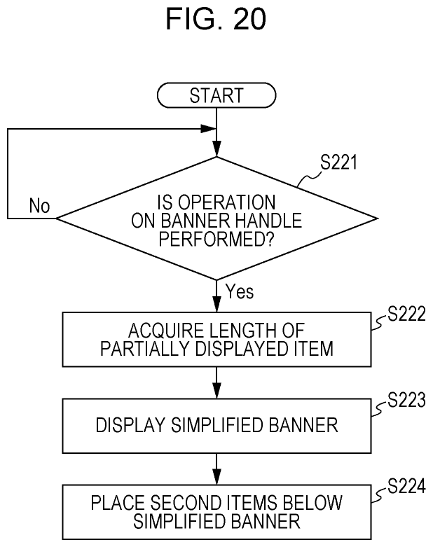

Next, a first modification of this exemplary embodiment will be described with reference to FIG. 20 in an appropriate manner.

### First Modification

In a first modification of the second exemplary embodiment, when an input operation on the banner handle 80 is performed by the user, the simplified banner 170S is displayed while display of a second item 64 the whole of which has been displayed in the display range 50 being maintained, as in the first modification of the first exemplary embodiment. Other operations are similar to those in the second exemplary embodiment.

Next, a processing procedure for the CPU 31 to execute the information processing program and display the objects 60 in the display range 50 of the screen in this modification will be described with reference to FIG. 20. In this modification, an operation (step S203 in FIG. 19) corresponding to a processing operation for displaying the simplified banner 170S in the second exemplary embodiment will be described, and the other operations are similar to those in the second exemplary embodiment.

As illustrated in FIG. 20, in step S221, the CPU 31 determines whether or not an input operation on the banner handle 80 is performed. In the case where it is determined that the result of the determination in step S221 is affirmative, the CPU 31 proceeds to step S222. In the case where the result of the determination in step S221 is negative, the CPU 31 repeats the processing of step S221.

In step S222, the CPU 31 acquires the length of a part of the partially displayed item 164 that is partially displayed in the display range 50 of the screen, the part of the partially displayed item 164 being displayed in the display range 50 of the screen. In the case where the result of the determination in step S222 is positive, the CPU 31 repeats the processing of step S223.

In step S223, the CPU 31 displays the simplified banner 170S on the top of the display range 50 of the screen. Then, the CPU 31 proceeds to step S224.

In step S224, the CPU 31 displays the second items 64 that were displayed in the display range 50 of the screen at the time when the processing of step S221 was performed below the simplified banner 170S. More specifically, the CPU 31 moves the second item 64 that have been displayed in the display range 50 of the screen downward by the value obtained in step S222.

The CPU 31 displays the objects 60 in the display range 50 of the screen in accordance with the procedure described above. Next, operation and effects in this modification will be described.

### Operation and Effects

Operation and effects in this modification are similar to those in the second exemplary embodiment. Furthermore, the CPU 31 may perform both the processing operations of the program according to this modification and the processing operations of the program according to the second exemplary embodiment.

### Other Modifications

As described above, in this exemplary embodiment, the simplified banner 170S is displayed, for example, on the top of the display range 50 of the screen. However, the simplified banner 170S is not necessarily displayed on the top of the display range 50 of the screen and may be displayed at any position with respect to the second items 64. For example, the simplified banner 170S may be displayed on the bottom of the display range 50 of the screen, instead of on the top of the display range 50 of the screen.

Furthermore, in this exemplary embodiment and the modifications thereof, in the case where the simplified banner 170S is displayed, even if an input operation is performed by a user, the displayed simplified banner 170S is not necessarily deleted. For example, the simplified banner 170S may be displayed on the screen until the simplified banner 170S is scrolled out by a scroll operation by the user. Furthermore, in this case, when the simplified banner 170S is scrolled output, the simplified banner 170S may be deleted and, after that, the first item 62 may be displayed as the simplified banner 170S.

Furthermore, in this exemplary embodiment and the modifications thereof, in the case where the first item 62 is displayed as the simplified banner 170S, when the first item 62 (that is, an e-mail address) is displayed again by a scroll operation by the user, the simplified banner 170S may be deleted.

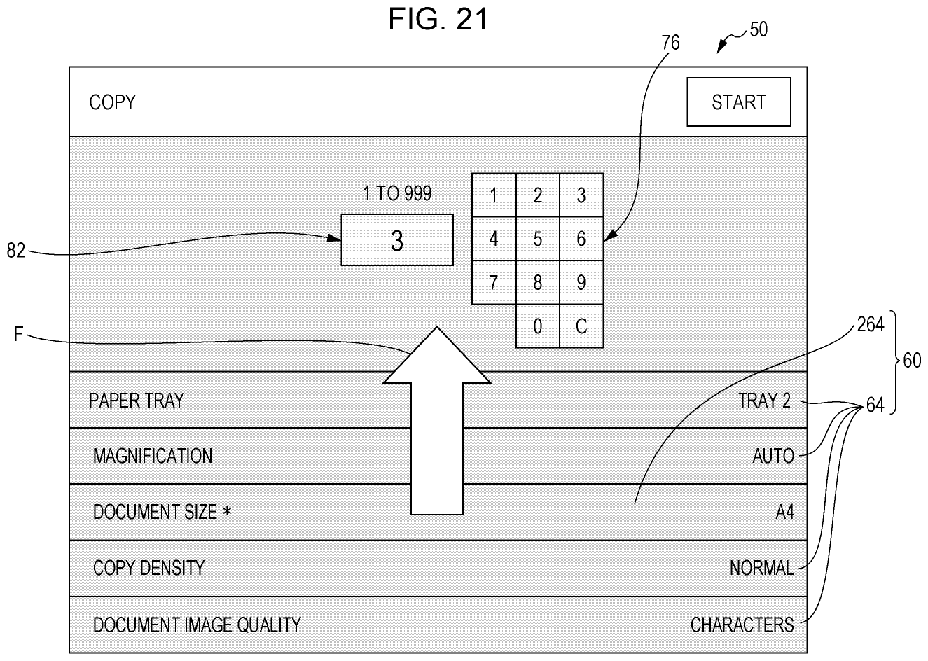

Next, a third exemplary embodiment of the present disclosure will be described with reference to FIGS. 21 to 25. In this exemplary embodiment, components similar to those in other exemplary embodiments will be denoted by signs similar to those in the other exemplary embodiments and the modifications thereof, and detailed description of those components will be omitted.

### Third Exemplary Embodiment

### (Screen Display Items)

FIG. 21 is a diagram illustrating a copy setting screen in a third exemplary embodiment of the present disclosure. In this exemplary embodiment, a first item is the number-of-copies item 82, as in the second modification of the first exemplary embodiment.

In this exemplary embodiment, for example, an asterisk mark “*” is added to an object 60 corresponding to an item for which a setting value is changed from an initial value (default value) by an input operation by the user. For example, in FIG. 21, an input operation on an item “document size” is performed by the user. In this exemplary embodiment, an item for which a setting value is changed from an initial value by an input operation by the user will be referred to as a set item 264.

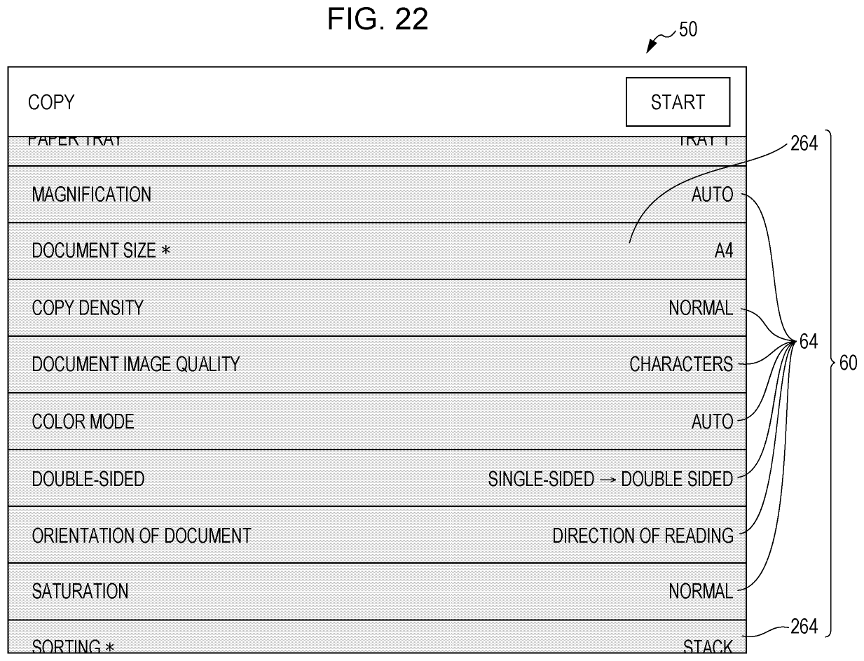

Furthermore, also in this exemplary embodiment, the objects 60 are moved in the same direction by a scroll operation by the user. For example, as illustrated in FIG. 21, in the case where the plurality of objects 60 including the number-of-copies item 82 are displayed, when a scroll operation in the direction of the arrow F is performed, the individual items are moved toward the direction of the scroll operation, as illustrated in FIG. 22.

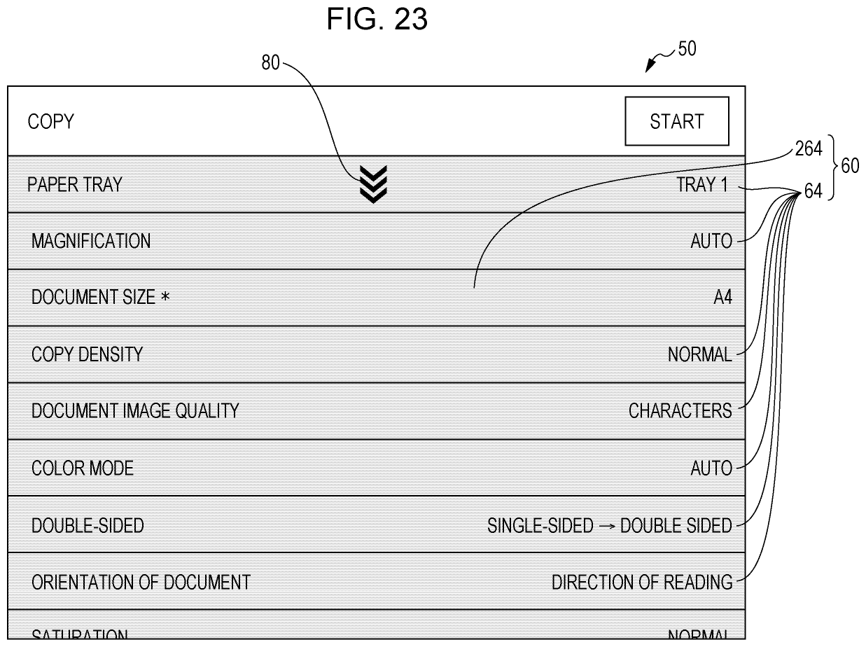

In the case where the scroll operation continues to be performed, as illustrated in FIG. 23, the individual objects 60 are moved outside the display range 50 of the screen.

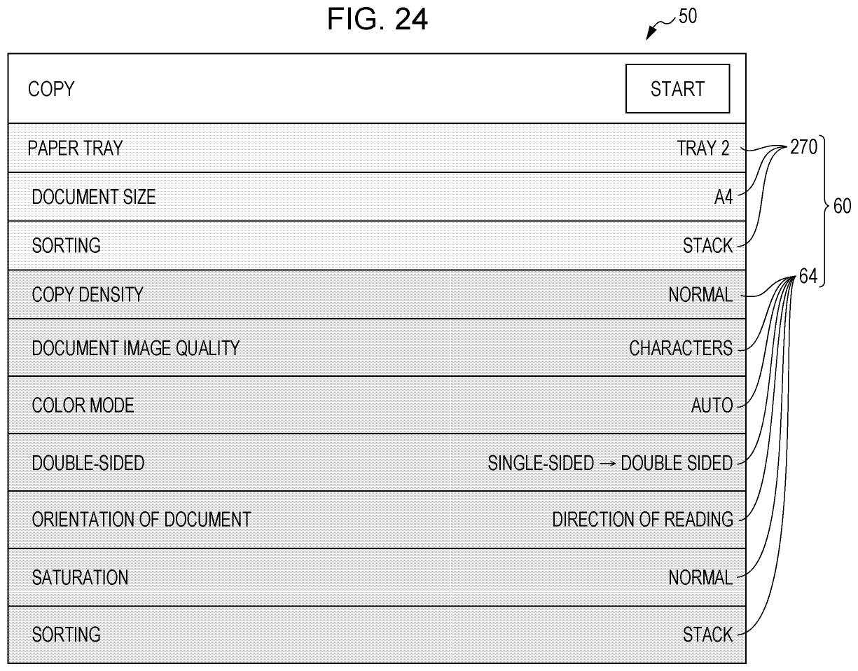

In this exemplary embodiment, the banner handle 80 is displayed in the state in which one of items on which an input operation is performed is scrolled out from the display range 50 of the screen. Then, when the user performs an input operation on the banner handle 80, as illustrated in FIG. 24, a set item 264 is displayed as a simplified banner 270. In this exemplary embodiment, in the case where there are a plurality of set items 264, the plurality of set items 264 are displayed as corresponding simplified banners 270, as illustrated in FIG. 24.

When the user performs an input operation on a simplified banner 270 in the state illustrated in FIG. 24, details of the selected set item 264 are displayed. That is, in this exemplary embodiment, a plurality of items for which settings are able to be changed by the user are displayed, and a specific item is defined based on an item for which setting has been changed by the user.

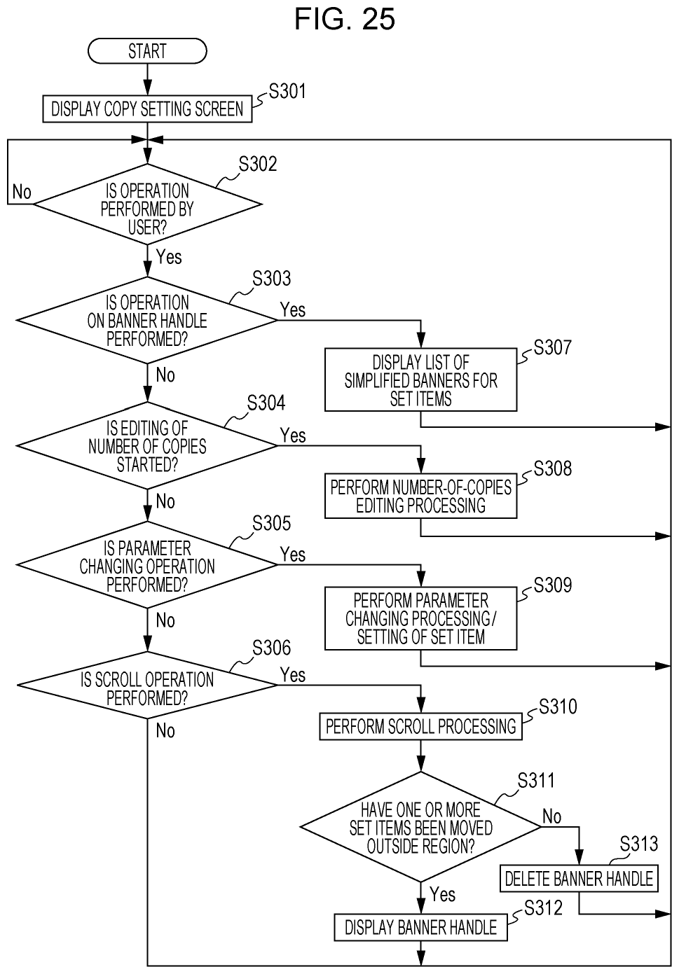

Next, in this exemplary embodiment, a processing procedure for the CPU 31 to execute the information processing program and display the objects 60 in the display range 50 of the screen will be described with reference to FIG. 25.

As illustrated in FIG. 25, the CPU 31 displays a copy setting screen in step S301, and then proceeds to step S302.

In step S302, the CPU 31 determines whether or not an operation is performed by the user. In the case where the result of the determination in step S302 is affirmative, the CPU 31 proceeds to step S303. In the case where the result of the determination in step S302 is negative, the CPU 31 repeats the processing of step S302.

In step S303, the CPU 31 determines whether or not an input operation on the banner handle 80 is performed by the user. In the case where the banner handle 80 is not displayed (for example, the CPU 31 proceeds to step S303 before the banner handle 80 is displayed), the CPU 31 obtains a negative determination result. In the case where the result of the determination in step S303 is affirmative, the CPU 31 proceeds to step S307. In the case where the result of the determination in step S303 is negative, the CPU 31 proceeds to step S304.

In step S304, the CPU 31 determines whether or not an input operation on the number-of-copies item 82, which is a first item, is performed by the user. In the case where the result of the determination in step S304 is affirmative, the CPU 31 proceeds to step S308. In the case where the result of the determination in step S304 is negative, the CPU 31 proceeds to step S305.

In step S305, the CPU 31 determines whether or not an operation for changing a parameter for a second item 64 is performed by the user. In the case where the result of the determination in step S305 is affirmative, the CPU 31 proceeds to step S309. In the case where the result of the determination in step S305 is negative, the CPU 31 proceeds to step S306.

In step S306, the CPU 31 determines whether or not a scroll operation is performed by the user. In the case where the result of the determination in step S306 is affirmative, the CPU 31 proceeds to step S310. In the case where the result of the determination in step S306 is negative, the CPU 31 proceeds to step S302.

In step S310, the CPU 31 changes display of the display range 50 of the screen in response to the scroll operation by the user. Then, in the case where it is determined that the scroll processing is completed, the CPU 31 proceeds to step S311.

In step S311, the CPU 31 determines whether or not one or more set items 264 are scrolled out from the display range 50 of the screen. In the case where the result of the determination in step S311 is affirmative, the CPU 31 proceeds to step S312. In the case where the result of the determination in step S311 is negative, the CPU 31 proceeds to step S313.

In step S312, the CPU 31 displays the banner handle 80 in the display range 50 of the screen. Then, the CPU 31 proceeds to step S302.

In step S313, the CPU 31 deletes the banner handle 80 from the display range 50 of the screen. Then, the CPU 31 proceeds to step S302.

In step S307, the CPU 31 displays the list of the simplified banners 270 for the set items 264, as illustrated in FIG. 24. In step S307, in the case where editing of a set item 264 is performed by the user, the CPU 31 performs processing for changing the set item 264. Then, in the case where it is determined that the processing for changing the set item 264 by the user is completed, the CPU 31 proceeds to step S302.

In step S308, the CPU 31 receives the input operation on the number-of-copies item 82 by the user. Then, in the case where it is determined that the processing for editing the number-of-copies item 82 is completed, the CPU 31 proceeds to step S302.

In step S309, the CPU 31 receives the input operation on the parameter for the second item 64 by the user. Furthermore, the CPU 31 sets the second item 64 for which the editing processing has been performed by the user as the set item 264, which is a specific item. Then, in the case where it is determined that the processing for editing the parameter for the second item 64 is completed, the CPU 31 proceeds to step S302.

The CPU 31 displays the objects 60 in the display range 50 of the screen in accordance with the procedure described above. Next, operation and effects in this exemplary embodiment will be described.

### Operation and Effects

In the information processing program according to this exemplary embodiment, a plurality of items for which settings are able to be changed by the user are displayed, and a specific item is defined based on an item for which setting has been changed by the user.

Thus, with the information processing program according to this exemplary embodiment, compared to a case where only a preset item is defined as a specific item, a setting item intended by the user is likely to be displayed.

Other operation and effects are similar to those in other exemplary embodiments. Furthermore, the CPU 31 may perform both the processing operations of the program according to this exemplary embodiment and the processing operations of a program according to another exemplary embodiment.

### Modifications

Modifications similar to those of the first exemplary embodiment and the second exemplary embodiment may be implemented also in this exemplary embodiment.

Furthermore, although an asterisk mark is added to a set item 264 for which a setting value has been changed from an initial value in this exemplary embodiment, the processing operations of the program according to this exemplary embodiment do not necessarily include adding an asterisk mark. That is, a set item 264 for which a setting value has been changed from an initial value and the second items 64 may be displayed in similar manners.

The exemplary embodiments of the present disclosure have been described above with reference to the attached drawings. It is obvious to those of ordinary skilled in the art to which the present disclosure belongs that various changes and applications can be made within the scope of the technical concept described in the claims, and it is to be understood that they naturally belong to the technical scope of the present disclosure.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

((1))

An information processing program for causing a computer to execute a process comprising:
changing display positions of a plurality of items in accordance with a direction of a scroll operation on a screen; and
stopping the scroll operation when a specific item among the plurality of items has been moved outside a display range in response to the scroll operation or displaying the specific item on part of the screen when an input is provided to a predetermined region on the screen.

((2))

The information processing program according to ((1)), wherein when a deletion operation on the screen is received in a state in which the specific item is displayed on the part of the screen, display of the specific item is deleted.

((3))

The information processing program according to ((2)), wherein when, as the deletion operation, an input to a deletion input part added to the specific item is provided, the specific item is deleted from the screen.

((4))

The information processing program according to ((2)), wherein when, as the deletion operation, selection of a second item other than the specific item is performed, the specific item is deleted from the screen.

((5))

The information processing program according to ((2)), wherein when, as the deletion operation, the scroll operation on the screen is performed, the specific item is deleted from the screen.

((6))

The information processing program according to any one of ((1)) to ((5)), wherein the specific item is displayed so as to be superimposed on a display position of a second item other than the specific item.

((7))

The information processing program according to ((6)), wherein transparency processing for making the specific item transparent so that a user is able to recognize the second item on which the specific item is superimposed is performed on the specific item.

((8))

The information processing program according to any one of ((1)) to ((5)), wherein the specific item is displayed while display of an item the whole of which is displayed in the display range being maintained.

((9))

The information processing program according to any one of ((1)) to ((8)), wherein the specific item is displayed in a display manner different from a display manner in which a second item other than the specific item is displayed.

((10))

The information processing program according to ((9)), wherein, as the display manners, the specific item and the second item are displayed in different colors.

((11))

The information processing program according to any one of ((1)) to ((10)),
wherein, as the plurality of items, items for which settings are able to be changed by a user, are displayed, and
wherein the specific item is defined based on an item for which the setting has been changed by the user.

((12))

The information processing program according to any one of ((1)) to ((11)), wherein when the specific item is selected in a state in which the specific item is displayed, the specific item is enabled to be edited.

((13))

An information display system comprising:
a processor configured to:
change display positions of a plurality of items in accordance with a direction of a scroll operation on a screen; and
stop the scroll operation when a specific item among the plurality of items has been moved outside a display range in response to the scroll operation or display the specific item on part of the screen when an input is provided to a predetermined region on the screen.

What is claimed is:

1. A non-transitory computer readable medium storing a program causing a computer to execute a process for information processing, the process comprising:
changing display positions of a plurality of items in accordance with a direction of a scroll operation on a screen; and
stopping the scroll operation when a specific item among the plurality of items has been moved outside a display range in response to the scroll operation or displaying the specific item on part of the screen when an input is provided to a predetermined region on the screen.

2. The non-transitory computer readable medium according to claim 1, wherein when a deletion operation on the screen is received in a state in which the specific item is displayed on the part of the screen, display of the specific item is deleted.

3. The non-transitory computer readable medium according to claim 2, wherein when, as the deletion operation, an input to a deletion input part added to the specific item is provided, the specific item is deleted from the screen.

4. The non-transitory computer readable medium according to claim 2, wherein when, as the deletion operation, selection of a second item other than the specific item is performed, the specific item is deleted from the screen.

5. The non-transitory computer readable medium according to claim 2, wherein when, as the deletion operation, the scroll operation on the screen is performed, the specific item is deleted from the screen.

6. The non-transitory computer readable medium according to claim 1, wherein the specific item is displayed so as to be superimposed on a display position of a second item other than the specific item.

7. The non-transitory computer readable medium according to claim 6, wherein transparency processing for making the specific item transparent so that a user is able to recognize the second item on which the specific item is superimposed is performed on the specific item.

8. The non-transitory computer readable medium according to claim 1, wherein the specific item is displayed while display of an item the whole of which is displayed in the display range being maintained.

9. The non-transitory computer readable medium according to claim 1, wherein the specific item is displayed in a display manner different from a display manner in which a second item other than the specific item is displayed.

10. The non-transitory computer readable medium according to claim 9, wherein, as the display manners, the specific item and the second item are displayed in different colors.

11. The non-transitory computer readable medium according to claim 1,
wherein, as the plurality of items, items for which settings are able to be changed by a user, are displayed, and
wherein the specific item is defined based on an item for which the setting has been changed by the user.

12. The non-transitory computer readable medium according to claim 1, wherein when the specific item is selected in a state in which the specific item is displayed, the specific item is enabled to be edited.

13. The non-transitory computer readable medium according to claim 2, wherein when the specific item is selected in a state in which the specific item is displayed, the specific item is enabled to be edited.

14. The non-transitory computer readable medium according to claim 3, wherein when the specific item is selected in a state in which the specific item is displayed, the specific item is enabled to be edited.

15. The non-transitory computer readable medium according to claim 4, wherein when the specific item is selected in a state in which the specific item is displayed, the specific item is enabled to be edited.

16. The non-transitory computer readable medium according to claim 5, wherein when the specific item is selected in a state in which the specific item is displayed, the specific item is enabled to be edited.

17. The non-transitory computer readable medium according to claim 6, wherein when the specific item is selected in a state in which the specific item is displayed, the specific item is enabled to be edited.

18. The non-transitory computer readable medium according to claim 7, wherein when the specific item is selected in a state in which the specific item is displayed, the specific item is enabled to be edited.

19. An information display system comprising:
a processor configured to:
change display positions of a plurality of items in accordance with a direction of a scroll operation on a screen; and
stop the scroll operation when a specific item among the plurality of items has been moved outside a display range in response to the scroll operation or display the specific item on part of the screen when an input is provided to a predetermined region on the screen.

20. An information processing method comprising:
changing display positions of a plurality of items in accordance with a direction of a scroll operation on a screen; and
stopping the scroll operation when a specific item among the plurality of items has been moved outside a display range in response to the scroll operation or displaying the specific item on part of the screen when an input is provided to a predetermined region on the screen.
